(19) United States
(12) Patent Application Publication
(10) Pub. No.: US 2026/0287812 A1
(43) Pub. Date: Sep. 24, 2026

(54) RESIN COMPOSITION, OPTICAL FIBER, OPTICAL FIBER MANUFACTURING METHOD, OPTICAL FIBER RIBBON, AND OPTICAL FIBER CABLE

(71) Applicant: SUMITOMO ELECTRIC INDUSTRIES, LTD., Osaka (JP)

(72) Inventor: Yuya HOMMA, Osaka (JP)

(21) Appl. No.: 19/479,913

(22) PCT Filed: May 10, 2024
(86) PCT No.: PCT/JP2024/017506

§ 371 Date: Oct. 29, 2025

(30) Foreign Application Priority Data
May 16, 2023 (JP) 2023-080640

(51) Int. Cl. G02B 6/02; C03C 25/105; C09D 4/00; C09D 7/63; C09D 133/14; G02B 6/44

(52) U.S. Cl. CPC G02B 6/02395; C03C 25/105; C09D 4/00; C09D 7/63; C09D 133/14; G02B 6/4403; C03C 2218/32

(57) ABSTRACT

A resin composition for primary coating of an optical fiber contains photopolymerizable compounds including a bifunctional urethane (meth)acrylate (A) and a monofunctional urethane (meth)acrylate (B), a photopolymerization initiator, and a silane coupling agent, in which the urethane (meth)acrylate (A) is a reaction product of a diol having a number average molecular weight of 8000 or more and 20000 or less, a diisocyanate, and a hydroxyl group-containing (meth)acrylate, a total amount of vinyl groups in 100 parts by mass of a total amount of the resin composition is 70 mmol or more and 200 mmol or less, and a ratio of an amount of vinyl groups of the urethane (meth)acrylate (B) with respect to an amount of vinyl groups of the urethane (meth)acrylate (A) is 3.7 or more and 15.0 or less.

### TECHNICAL FIELD

The present disclosure relates to a resin composition for primary coating of an optical fiber, an optical fiber, a method for producing an optical fiber, an optical fiber ribbon, and an optical fiber cable.

The present application claims the priority based on Japanese patent application No. 2023-080640, filed on May 16, 2023, and the content described in the Japanese application is incorporated herein in its entirety.

### BACKGROUND ART

Generally, an optical fiber is provided with a coating resin layer for protecting a glass fiber, which is an optical transmission medium. For example, the coating resin layer comprises two layers that are a primary resin layer in contact with the glass fiber and a secondary resin layer formed on the outer layer of the primary resin layer. When the packing density of optical fibers is increased, external force (lateral pressure) is applied to the optical fibers, and the microbending loss is likely to increase. In order to improve the microbending resistance characteristics of an optical fiber, it is known to decrease the Young's modulus of the primary resin layer and to increase the Young's modulus of the secondary resin layer. For example, resin compositions for primary coating containing a urethane (meth)acrylate, which is a reaction product of a polyol, a diisocyanate, and a hydroxyl group-containing (meth)acrylate are described in Patent Literatures 1 to 5.

### CITATION LIST

### Patent Literature

[Patent Literature 1] JP 2009-197163 A
[Patent Literature 2] JP 2012-111674 A
[Patent Literature 3] JP 2013-136783 A
[Patent Literature 4] JP 2013-501125 A
[Patent Literature 5] JP 2014-114208 A

### SUMMARY OF INVENTION

A resin composition for primary coating of an optical fiber according to an aspect of the present disclosure comprises photopolymerizable compounds including a bifunctional urethane (meth)acrylate (A) and a monofunctional urethane (meth)acrylate (B), a photopolymerization initiator, and a silane coupling agent, in which the urethane (meth)acrylate (A) is a reaction product of a diol having a number average molecular weight of 8000 or more and 20000 or less, a diisocyanate, and a hydroxyl group-containing (meth)acrylate, and a total amount of vinyl groups in 100 parts by mass of a total amount of the resin composition is 70 mmol or more and 200 mmol or less, and a ratio of an amount of vinyl groups of the urethane (meth)acrylate (B) with respect to an amount of vinyl groups of the urethane (meth)acrylate (A) is 3.7 or more and 15.0 or less.

### BRIEF DESCRIPTION OF DRAWINGS

FIG. 1 is a schematic cross-sectional view showing an example of an optical fiber according to the present embodiment.

FIG. 2 is a schematic cross-sectional view showing an optical fiber ribbon according to an embodiment.

FIG. 3 is a schematic cross-sectional view showing an optical fiber ribbon according to an embodiment.

FIG. 4 is a plan view showing the appearance of an optical fiber ribbon according to an embodiment.

FIG. 5 is a schematic cross-sectional view showing an optical fiber cable according to an embodiment.

FIG. 6 is a schematic cross-sectional view showing an optical fiber cable according to an embodiment.

### DESCRIPTION OF EMBODIMENTS

### Problem to be Solved by Present Disclosure

In order to improve the microbending resistance characteristics of an optical fiber, when the Young's modulus of the primary resin layer is decreased, the transmission loss at low temperatures is likely to increase. When the production speed of an optical fiber is increased, the Young's modulus of the primary resin layer is further decreased, and the transmission loss at low temperature is likely to increase.

It is an object of the present disclosure to provide a resin composition that can form a primary resin layer of an optical fiber having excellent microbending resistance characteristics and low-temperature characteristics, and an optical fiber having excellent microbending resistance characteristics and low-temperature characteristics.

### Effect of Present Disclosure

According to the present disclosure, a resin composition that can form a primary resin layer of an optical fiber having excellent microbending resistance characteristics and low-temperature characteristics, and an optical fiber having excellent microbending resistance characteristics and low-temperature characteristics, can be provided.

### Description of Embodiments of Present Disclosure

Firstly, the present disclosure will be described by listing the contents of the embodiments.

(1) A resin composition for primary coating of an optical fiber according to an aspect of the present disclosure comprises photopolymerizable compounds including a bifunctional urethane (meth)acrylate (A) and a monofunctional urethane (meth)acrylate (B), a photopolymerization initiator, and a silane coupling agent, in which the urethane (meth)acrylate (A) is a reaction product of a diol having a number average molecular weight of 8000 or more and 20000 or less, a diisocyanate, and a hydroxyl group-containing (meth)acrylate, a total amount of vinyl groups in 100 parts by mass of a total amount of the resin composition is 70 mmol or more and 200 mmol or less, and a ratio of an amount of vinyl groups of the urethane (meth)acrylate (B) with respect to an amount of vinyl groups of the urethane (meth)acrylate (A) is 3.7 or more and 15.0 or less.

Such a resin composition can form a resin layer suitable for primary coating of an optical fiber and can improve the microbending resistance characteristics and the low-temperature characteristics of an optical fiber.

(2) With regard to the above (1), from the viewpoint of further improving the low-temperature characteristics, the total amount of vinyl groups in 100 parts by mass of the total amount of the resin composition may be 80 mmol or more and 180 mmol or less.

(3) With regard to the above (1) or (2), from the viewpoint of making the thickness of the primary resin layer more uniform, the ratio of the amount of vinyl groups of the urethane (meth)acrylate (B) with respect to the amount of vinyl groups of the urethane (meth)acrylate (A) may be 4.0 or more and 10.0 or less.

(4) With regard to any one of the above (1) to (3), from the viewpoint of adjusting a Young's modulus of the primary resin layer, a content of the urethane (meth)acrylate (A) based on 100 parts by mass of the total amount of the resin composition may be 10 parts by mass or more and 40 parts by mass or less, and a content of the urethane (meth)acrylate (B) may be 30 parts by mass or more and 80 parts by mass or less.

(5) With regard to any one of the above (1) to (4), from the viewpoint of reducing the Young's modulus of the primary resin layer, the urethane (meth)acrylate (B) may be a reaction product of a monool having a number average molecular weight of 2000 or more and 6000 or less, a diisocyanate, and a hydroxyl group-containing (meth)acrylate.

(6) With regard to any one of the above (1) to (5), in order to improve the curing rate of the resin composition, the photopolymerizable compounds may further include an N-vinyl compound, and a content of the N-vinyl compound may be 1 part by mass or more and 15 parts by mass or less based on 100 parts by mass of the total amount of the resin composition.

(7) With regard to any one of the above (1) to (6), from the viewpoint of further improving the microbending resistance characteristics, a Young's modulus of a resin film obtained when the resin composition according to the present embodiment is ultraviolet-cured under conditions including an accumulated amount of light of 10 mJ/cm² and an illumination of 100 mW/cm² may be 0.20 MPa or more and 0.80 MPa or less at 23° C.

(8) With regard to the above (7), from the viewpoint of further improving the low-temperature characteristics and the microbending resistance characteristics of the optical fiber, the Young's modulus of the resin film may be 0.25 MPa or more and 0.80 MPa or less at 23° C.

(9) An optical fiber according to an aspect of the present disclosure comprises: a glass fiber including a core and a cladding; a primary resin layer coating the glass fiber in contact with the glass fiber; and a secondary resin layer coating the primary resin layer, and the primary resin layer includes a cured product of the resin composition according to any one of the above (1) to (8). Such an optical fiber is excellent in terms of the microbending resistance characteristics and the low-temperature characteristics.

(10) A method for producing an optical fiber according to an aspect of the present disclosure comprises: an application step of applying the resin composition according to any one of the above (1) to (8) on an outer periphery of a glass fiber including a core and a cladding; and a curing step of curing the resin composition by irradiating the resin composition with ultraviolet radiation after the application step. As a result, an optical fiber having excellent microbending resistance characteristics and low-temperature characteristics can be produced.

(11) An optical fiber ribbon according to an aspect of the present disclosure is such that a plurality of the optical fibers according to the above (9) are arranged in parallel and coated with a resin for a ribbon. Such an optical fiber ribbon is excellent in terms of microbending resistance characteristics and low-temperature characteristics and can be packed with high density in an optical fiber cable.

(12) An optical fiber cable according to an aspect of the present disclosure is such that the optical fiber ribbon according to the above (11) is accommodated in a cable. Such an optical fiber cable including an optical fiber ribbon is excellent in terms of microbending resistance characteristics and low-temperature characteristics.

(13) An optical fiber cable according to an aspect of the present disclosure is such that a plurality of the optical fibers according to the above (9) are accommodated in a cable. Such an optical fiber cable is excellent in terms of the microbending resistance characteristics and the low-temperature characteristics.

### Details of Embodiments of Present Disclosure

Specific examples of the resin composition and the optical fiber according to the present embodiment will be described with reference to the drawings as necessary. The present disclosure is not limited to these examples but is shown in the scope of claims, and it is intended that all modifications in the meanings and scopes equivalent to the scope of claims are included in the present disclosure. In the following description, the same elements in the description of the drawings will be assigned with the same reference numerals, and overlapping descriptions will not be repeated here. The term (meth)acrylate as used in the present specification means acrylate or methacrylate corresponding thereto, and the same also applies to other similar expressions such as (meth)acryloyl.

### (Resin Composition)

The resin composition according to the present embodiment is a resin composition for primary coating of an optical fiber, containing photopolymerizable compounds including a bifunctional urethane (meth)acrylate (A) and a monofunctional urethane (meth)acrylate (B), a photopolymerization initiator, and a silane coupling agent. The resin composition according to the present embodiment is an ultraviolet-curable resin composition.

The total amount of vinyl groups in 100 parts by mass of the resin composition according to the present embodiment is 70 mmol or more and 200 mmol or less and may be 75 mmol or more and 190 mmol or less, 80 mmol or more and 180 mmol or less, or 84 mmol or more and 170 mmol or less. When the total amount of vinyl groups is less than 70 mmol, the Young's modulus of the primary layer is decreased, and the low-temperature characteristics of the optical fiber are easily deteriorated. When the total amount of vinyl groups is more than 200 mmol, it is difficult for the urethane (meth)acrylates to be incorporated into crosslinking when the resin composition is cured, and when the production speed of the optical fiber is increased, the low-temperature characteristics are easily deteriorated.

The vinyl group is a group derived from a compound having a photopolymerizable ethylenically unsaturated group contained in the resin composition. Examples of the compound having a photopolymerizable ethylenically unsaturated group include photopolymerizable compounds having a urethane bond, such as the urethane (meth)acrylate (A) and the urethane (meth)acrylate (B); photopolymerizable compounds that do not have a urethane bond; and silane compounds having a photopolymerizable ethylenically unsaturated group.

The amount of vinyl groups (mmol/g) of each compound can be determined by the number of vinyl groups/molecular weight×1000. For example, in the case of 2-ethylhexyl acrylate, since the number of vinyl groups is 1, and the molecular weight is 184.28, the amount of vinyl groups is 1/184.28×1000=5.427 (mmol/g). Furthermore, in the case of neopentyl glycol diacrylate, since the number of vinyl groups is 2, and the molecular weight is 212.25, the amount of vinyl groups is 2/212.25×1000=9.423 (mmol/g). The total amount of vinyl groups in 100 parts by mass of the resin composition can be determined by the total sum of the amount of vinyl groups (mmol/g) of each compound×the percentage by mass of each compound.

The ratio of the amount of vinyl groups of the urethane (meth)acrylate (B) with respect to the amount of vinyl groups of the urethane (meth)acrylate (A) (amount of vinyl groups of urethane (meth)acrylate (B)/amount of vinyl groups of urethane (meth)acrylate (A)) in the resin composition is 3.7 or more and 15.0 or less. When the ratio is 3.7 or more, the eccentricity of wall thickness of the primary resin layer with respect to the glass fiber is less likely to decrease, and when the ratio is 15.0 or less, the crosslinking density of the primary resin layer is less likely to decrease, while the low-temperature characteristics of the optical fiber are easily improved. The ratio may be 3.8 or more and 14.0 or less, 3.9 or more and 12.0 or less, or 4.0 or more and 10.0 or less.

For example, in a case where the resin composition includes 20% by mass of the urethane (meth)acrylate (A) and 50% by mass of the urethane (meth)acrylate (B), and the amount of vinyl groups of the urethane (meth)acrylate (A) is 0.15 mmol/g, while the amount of vinyl groups of the urethane (meth)acrylate (B) is 0.30 mmol/g, the amount of vinyl groups of the urethane (meth)acrylate (B) with respect to the amount of vinyl groups of the urethane (meth)acrylate (A) in the resin composition can be calculated as (0.30×50%)/(0.15×20%)=5.0.

The proportion of the amount of vinyl groups of the urethane (meth)acrylate (A) in the total amount of vinyl groups in the resin composition may be 1.0% or more and 5.0% or less, 1.5% or more and 4.5% or less, or 2.0% or more and 4.0% or less. The proportion of the amount of vinyl groups of the urethane (meth)acrylate (B) in the total amount of vinyl groups in the resin composition may be 5.0% or more and 35% or less, 7.0% or more and 30% or less, 8.0% or more and 28% or less, or 9.5% or more and 27% or less. The proportion of the total amount of vinyl groups of the urethane (meth)acrylate (A) and the urethane (meth)acrylate (B) in the total amount of vinyl groups in the resin composition may be 6.0% or more and 40% or less, 8.0% or more and 35% or less, or 10% or more and 30% or less.

The urethane (meth)acrylate (A) has two (meth)acryloyl groups, and is a reaction product of a diol having a number average molecular weight of 8000 or more and 20000 or less, a diisocyanate, and a hydroxyl group-containing (meth)acrylate.

Examples of the diol include a polyether diol, a polyester diol, a polycaprolactone diol, a polycarbonate diol, a polybutadiene diol, and a bisphenol A-ethylene oxide adduct diol. Examples of the polyether diol include polytetramethylene glycol (PTMG), polyethylene glycol (PEG), polypropylene glycol (PPG), a block copolymer of PTMG-PPG-PTMG, a block copolymer of PEG-PPG-PEG, a random copolymer of PTMG-PEG, and a random copolymer of PTMG-PPG. From the viewpoint of easily adjusting the Young's modulus of the resin layer, polypropylene glycol may be used as the diol.

The number average molecular weight (Mn) of the diol may be 8000 or more and 20000 or less, 10000 or more and 20000 or less, 11000 or more and 20000 or less, or 12000 or more and 20000 or less, 15000 or more and 19000 or less.

Examples of the diisocyanate include 2,4-tolylene diisocyanate, 2,6-tolylene diisocyanate, isophorone diisocyanate, dicyclohexylmethane diisocyanate, diphenylmethane diisocyanate, hexamethylene diisocyanate, xylylene diisocyanate, hydrogenated xylylene diisocyanate, 1,5-naphthalene diisocyanate, norbornene diisocyanate, 1,5-pentamethylene diisocyanate, tetramethylxylylene diisocyanate, and trimethylhexamethylene diisocyanate.

Examples of the hydroxyl group-containing (meth)acrylate include 2-hydroxyethyl (meth)acrylate, 2-hydroxypropyl (meth)acrylate, 2-hydroxybutyl (meth)acrylate, caprolactone (meth)acrylate, 2-hydroxy-3-phenoxypropyl (meth)acrylate, 2-(meth)acryloyloxyethyl-2-hydroxyethylphthalic acid, 2-hydroxy-o-phenylphenolpropyl (meth)acrylate, 2-hydroxy-3-methacrylpropyl acrylate, trimethylolpropane di(meth)acrylate, and pentaerythritol tri(meth)acrylate. From the viewpoint of reactivity, 2-hydroxyethyl acrylate may be used as the hydroxyl group-containing (meth)acrylate.

Examples of a method for preparing the urethane (meth)acrylate (A) include a method of reacting a diol with a diisocyanate to synthesize an isocyanate group (NCO)-terminated prepolymer and then reacting the prepolymer with a hydroxyl group-containing (meth)acrylate; a method of reacting a diisocyanate with a hydroxyl group-containing (meth)acrylate and then reacting the resultant with a diol; and a method of simultaneously reacting a diol, a diisocyanate, and a hydroxyl group-containing (meth)acrylate.

The molar ratio of NCO and OH (NCO/OH) at the time of reacting the diol and the diisocyanate may be 1.1 or more and 4.0 or less, 1.2 or more and 3.5 or less, or 1.4 or more and 3.0 or less. The molar ratio of the hydroxyl group-containing (meth)acrylate with respect to NCO of the NCO-terminated prepolymer may be 1.00 or more and 1.15 or less, 1.01 or more and 1.12 or less, or 1.03 or more and 1.10 or less.

The urethane (meth)acrylate (B) has one (meth)acryloyl group, from the viewpoint of reducing the Young's modulus of the primary resin layer. The urethane (meth)acrylate (B) may be a reaction product of a monool having a number average molecular weight of 2000 or more and 10000 or less, a diisocyanate, and a hydroxyl group-containing (meth)acrylate.

An example of the monool may be a polyoxyalkylene monoalkyl ether. The polyoxyalkylene monoalkyl ether is a compound having an oxyalkylene group, an alkoxy group, and a hydroxyl group.

Examples of the polyoxyalkylene monoalkyl ether include polyoxyethylene oleyl ether, polyoxyethylene lauryl ether, polyoxyethylene cetyl ether, polyoxyethylene stearyl ether, polyoxyethylene alkyl (C₁₂-C₁₄) ether, polyoxyethylene tridecyl ether, polyoxyethylene myristyl ether, polyoxyethylene isostearyl ether, polyoxyethylene octyl dodecyl ether, polyoxyethylene cholesteryl ether, polyoxypropylene butyl ether, polyoxypropylene myristyl ether, polyoxypropylene cetyl ether, polyoxypropylene stearyl ether, polyoxypropylene lanolin alcohol ether, polyoxyethylene polyoxypropylene butyl ether, polyoxyethylene polyoxypropylene lauryl ether, polyoxyethylene polyoxypropylene cetyl ether, polyoxyethylene polyoxypropylene stearyl ether, and polyoxyethylene polyoxypropylene decyl tetradecyl ether.

From the viewpoint of compatibility of the resin composition, the polyoxyalkylene monoalkyl ether may be polyoxypropylene monobutyl ether.

From the viewpoint of obtaining a Young's modulus suitable for the primary resin layer, the Mn of the polyoxyalkylene monoalkyl ether may be 2000 or more, 2100 or more, 2200 or more, or 2500 or more, and may be 10000 or less, 8000 or less, 7000 or less, or 6000 or less.

The Mn of the diol and the Mn of the monool can be obtained by measuring the hydroxyl group values based on JIS K 0070 and calculating the Mn's from the following expression. The number of functional groups of the diol is 2, and the number of functional groups of the monool is 1.

Mn=56.1×number of functional groups×1000/hydroxyl group value

From the viewpoint of obtaining a Young's modulus suitable for the primary resin layer, the Mn of the urethane (meth)acrylate (A) may be 10000 or more and 50000 or less, 12000 or more and 48000 or less, 14000 or more and 46000 or less, 16000 or more and 44000 or less, or 20000 or more and 40000 or less. The weight average molecular weight (Mw) of the urethane (meth)acrylate (A) may be 10000 or more and 80000 or less, 12000 or more and 78000 or less, 15000 or more and 75000 or less, 20000 or more and 70000 or less, or 25000 or more and 60000 or less.

The Mn of the urethane (meth)acrylate (B) may be 4000 or more and 20000 or less, 5000 or more and 18000 or less, 6000 or more and 15000 or less, or 6200 or more and 12000 or less. The Mw of the urethane (meth)acrylate (B) may be 4000 or more and 30000 or less, 4500 or more and 25000 or less, 5000 or more and 20000 or less, or 6000 or more and 18000 or less.

The Mn and Mw of the urethane (meth)acrylate (A) and the urethane (meth)acrylate (B) can be measured by gel permeation chromatography (GPC).

From the viewpoint of adjusting the Young's modulus of the primary resin layer, the content of the urethane (meth)acrylate (A) may be 10 parts by mass or more and 40 parts by mass or less, 15 parts by mass or more and 35 parts by mass or less, or 15 parts by mass or more and 30 parts by mass or less, based on 100 parts by mass of the total amount of the resin composition.

From the viewpoint of adjusting the Young's modulus of the primary resin layer, the content of the urethane (meth)acrylate (B) may be 30 parts by mass or more and 80 parts by mass or less, 35 parts by mass or more and 75 parts by mass or less, or 40 parts by mass or more and 70 parts by mass or less, based on 100 parts by mass of the total amount of the resin composition.

The total amount of the urethane (meth)acrylate (A) and the urethane (meth)acrylate (B) may be 50 parts by mass or more and 95 parts by mass or less, 60 parts by mass or more and 90 parts by mass or less, or 65 parts by mass or more and 85 parts by mass or less, based on 100 parts by mass of the total amount of the resin composition.

The photopolymerizable compounds according to the present embodiment may further include a photopolymerizable compound that does not have a urethane bond (hereinafter, referred to as “monomer”). Examples of the monomer include a (meth)acrylic acid ester, an N-vinyl compound, and a (meth)acrylamide compound. The monomer may be a monofunctional monomer having one photopolymerizable ethylenically unsaturated group, or may be a polyfunctional monomer having two or more ethylenically unsaturated groups.

Examples of the monofunctional (meth)acrylic acid ester include methyl (meth)acrylate, ethyl (meth)acrylate, propyl (meth)acrylate, n-butyl (meth)acrylate, s-butyl (meth)acrylate, t-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, phenoxyethyl (meth)acrylate, tetrahydrofurfuryl (meth)acrylate, benzyl (meth)acrylate, cyclic trimethylolpropane formal acrylate, dicyclopentenyl (meth)acrylate, dicyclopentenyl oxyethyl (meth)acrylate, dicyclopentanyl (meth)acrylate, methoxy polyethylene glycol (meth)acrylate, butoxy polyethylene glycol (meth)acrylate, nonylphenol polyethylene glycol (meth)acrylate, nonylphenoxy polyethylene glycol (meth)acrylate, isobornyl (meth)acrylate, 3-phenoxybenzyl (meth)acrylate, methylphenoxyethyl (meth)acrylate, phenoxy diethylene glycol (meth)acrylate, phenoxy polyethylene glycol (meth)acrylate, m-phenoxybenzyl (meth)acrylate, 2-(2-ethoxyethoxy)ethyl (meth)acrylate, 2-hydroxy-3-phenoxypropyl acrylate, carboxyethyl (meth)acrylate, carboxypentyl (meth)acrylate, and ω-carboxy polycaprolactone (meth)acrylate.

Examples of the polyfunctional (meth)acrylic acid ester include bifunctional monomers such as ethylene glycol di(meth)acrylate, polyethylene glycol di(meth)acrylate, polypropylene glycol di(meth)acrylate, neopentyl glycol di(meth)acrylate, tripropylene glycol di(meth)acrylate, triethylene glycol di(meth)acrylate, cyclohexane dimethanol di(meth)acrylate, dipropylene glycol di(meth)acrylate, tetraethylene glycol di(meth)acrylate, hydroxypivalic acid neopentyl glycol di(meth)acrylate, 1,3-butylene glycol di(meth)acrylate, 1,4-butanediol di(meth)acrylate, diethylene glycol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyldiol di(meth)acrylate, 3-ethyl-1,8-octanediol di(meth)acrylate, tricyclodecanol di(meth)acrylate, 9,9-bis[4-(2-hydroxyethoxy)phenyl]fluorene di(meth)acrylate, bisphenol A epoxy di(meth)acrylate, bisphenol F epoxy di(meth)acrylate, bisphenol A EO adduct di(meth)acrylate, bisphenol F EO adduct di(meth)acrylate, bisphenol A PO adduct di(meth)acrylate, and bisphenol F PO adduct di(meth)acrylate; and tri- or higher-functional monomers such as trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl]isocyanurate.

Examples of the (meth)acrylamide compound include dimethyl (meth)acrylamide, diethyl (meth)acrylamide, (meth)acryloylmorpholine hydroxymethyl (meth)acrylamide, hydroxyethyl (meth)acrylamide, isopropyl (meth)acrylamide, dimethylaminopropyl (meth)acrylamide, dimethylaminopropyl acrylamide/methyl chloride salt, diacetone acrylamide, (meth)acryloylpiperidine, (meth)acryloylpyrrolidine, (meth)acrylamide, N-hexyl (meth)acrylamide, N-methyl (meth)acrylamide, N-butyl (meth)acrylamide, N-methylol (meth)acrylamide, and N-methylolpropane (meth)acrylamide.

Examples of the N-vinyl compound include N-vinylpyrrolidone, N-vinylcaprolactam, N-vinylmethyloxazolidinone, N-vinylimidazole, and N-vinyl-N-methylacetamide. N-vinylcaprolactam or N-vinylmethyloxazolidinone may be used as the N-vinyl compound.

When the photopolymerizable compounds include an N-vinyl compound, the curing rate of the resin composition can be improved. The content of the N-vinyl compound may be 1 part by mass or more and 15 parts by mass or less, 2 parts by mass or more and 14 parts by mass or less, or 2.5 parts by mass or more and 13 parts by mass or less, based on 100 parts by mass of the total amount of the resin composition.

The content of the monomer may be 5 parts by mass or more and 40 parts by mass or less, 7 parts by mass or more and 37 parts by mass or less, or 10 parts by mass or more and 35 parts by mass or less, based on 100 parts by mass of the total amount of the resin composition.

The photopolymerization initiator can be appropriately selected from known radical photopolymerization initiators and used. Examples of the photopolymerization initiator include 1-hydroxycyclohexyl phenyl ketone (Omnirad 184, manufactured by IGM Resins B.V.), 2,2-dimethoxy-2-phenylacetophenone (Omnirad 651, manufactured by IGM Resins B.V.), 2,4,6-trimethylbenzoyl diphenylphosphine oxide (Omnirad TPO, manufactured by IGM Resins B.V.), ethyl (2,4,6-trimethylbenzoyl)-phenylphosphinate (Omnirad TPO-L, manufactured by IGM Resins B.V.), 2-benzyl-2-dimethylamino-4′-morpholinobutyrophenone (Omnirad 369, manufactured by IGM Resin B.V.), 2-dimethylamino-2-(4-methylbenzyl)-1-(4-morpholin-4-yl-phenyl)-butan-1-one (Omnirad 379, manufactured by IGM Resins B.V.), bis(2,4,6-trimethylbenzoyl)phenylphosphine oxide (Omnirad 819, manufactured by IGM Resins B.V.), and 2-methyl-1-[4-(methylthio)phenyl]-2-morpholinopropan-1-one (Omnirad 907, manufactured by IGM Resins B.V.).

Regarding the photopolymerization initiator, two or more kinds thereof may be used in combination. From the viewpoint that the resin composition has excellent fast curability, the photopolymerization initiator may include 2,4,6-trimethylbenzoyldiphenylphosphine oxide or ethyl (2,4,6-trimethylbenzoyl)-phenylphosphinate.

The content of the photopolymerization initiator may be 0.1 parts by mass or more and 5 parts by mass or less, 0.3 parts by mass or more and 4 parts by mass or less, or 0.4 parts by mass or more and 3 parts by mass or less based on 100 parts by mass of the total amount of the resin composition.

The resin composition according to the present embodiment may further contain a sensitizer, a photo-acid generator, a surfactant, a silane coupling agent, a leveling agent, an antifoaming agent, an antioxidant, an ultraviolet absorber, and the like.

Examples of the sensitizer include anthracene compounds such as 9,10-dibutoxyanthracene, 9,10-diethoxyanthracene, 9,10-dipropoxyanthracene, and 9,10-bis(2-ethylhexyloxy)anthracene; thioxanthone compounds such as 2,4-diethylthioxanthone, 2,4-diethylthioxanthen-9-one, 2-isopropylthioxanthone, and 4-isopropylthioxanthone; amine compounds such as triethanolamine, methyldiethanolamine, and triisopropanolamine; benzoin compounds, anthraquinone compounds, ketal compounds, and benzophenone compounds.

As the photo-acid generator, an onium salt having a structure of A⁺B⁻ may be used. Examples of the photo-acid generator include sulfonium salts such as CPI-100P, 101A, 110P, 200K, 210S, 310B, 410S (manufactured by San-Apro Ltd.), and Omnicat 270 and 290 (manufactured by IGM Resins B.V.); and iodonium salts such as CPI-IK-1 (manufactured by San-Apro Ltd.), Omnicat 250 (manufactured by IGM Resins B.V.), and WPI-113, 116, 124, 169, and 170 (manufactured by Fujifilm Wako Pure Chemical Corporation).

Examples of the surfactant include polyoxyethylene alkyl ether, polyoxyethylene sorbitan fatty acid ester, polyoxyethylene sorbitol fatty acid ester, polyoxyethylene monoester, polyoxyethylene diester, polyoxyethylene glyceryl isostearate, polyoxyethylene glyceryl triisostearate, sorbitan fatty acid ester, a compound represented by the following Formula (1), and a compound represented by the following Formula (2).

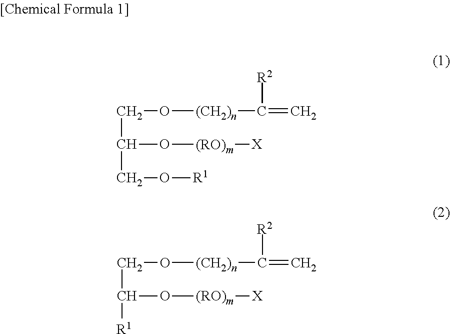

In Formula (1) and Formula (2), R represents an alkylene group having 2 to 4 carbon atoms; R¹ represents a hydrocarbon group having 1 to 20 carbon atoms; R² represents a hydrogen atom or a methyl group; X represents a hydrogen atom or SO₃NH₄; m represents an integer of 0 to 100; and n represents an integer of 0 to 12. In a case where m is 2 or more, a plurality of R's may be the same or different.

Examples of the alkylene group having 2 to 4 carbon atoms as represented by R include an ethylene group, a propylene group, and a butylene group. From the viewpoint of having more excellent water resistance and oil resistance, R may be an ethylene group. The number of carbon atoms of the hydrocarbon group represented by R¹ may be 5 to 20, 8 to 18, or 10 to 15, from the viewpoint of having more excellent water resistance and oil resistance. The hydrocarbon group represented by R¹ may be a straight-chained, branched, or cyclic group. The hydrocarbon group represented by R¹ may be an aliphatic hydrocarbon group or an aromatic hydrocarbon group. Examples of the aliphatic hydrocarbon group include an alkyl group having 1 to 20 carbon atoms.

Examples of the aromatic hydrocarbon group include a phenyl group substituted with an alkyl group. The number of carbon atoms of the alkyl group in the phenyl group substituted with an alkyl group may be 1 to 14 or 1 to 10. Examples of the phenyl group substituted with an alkyl group include an octylphenyl group and a nonylphenyl group. R² may be a hydrogen atom, from the viewpoint of having more excellent water resistance and oil resistance. m may be an integer of 1 to 50, 2 to 40, 3 to 30, 4 to 25, or 5 to 20. n may be an integer of 0 to 10, 0 to 8, 0 to 6, 0 to 3, or 1 to 3.

Examples of the compound represented by Formula (1) include ADEKA REASOAP SR-10, SR-20, SR-1025, SR-2025, SR-3025, SE-10 N, SE-1025 A, ER-10, ER-20, ER-30, ER-40, NE-10, NE-20, and NE-30 manufactured by ADEKA Corporation. Examples of the compound represented by Formula (2) include AQUALON KH-05, KH-10, and KH-20 manufactured by DKS Co. Ltd.

Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy)silane, 3-(meth)acryloxypropyltrimethoxysilane, β-(3,4-epoxycyclohexyl)-ethyltrimethoxysilane, dimethoxydimethylsilane, diethoxydimethylsilane, γ-glycidoxypropyltrimethoxysilane, γ-glycidoxypropylmethyldiethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl)propyl]tetrasulfide, bis-[3-(triethoxysilyl)propyl]disulfide, γ-trimethoxysilylpropyl dimethylthiocarbamoyl tetrasulfide, and γ-trimethoxysilylpropyl benzothiazyl tetrasulfide. From the viewpoint of adjusting the amount of vinyl groups in the resin composition, a silane compound having a photopolymerizable ethylenically unsaturated group, such as vinyltrichlorosilane, vinyltriethoxysilane, vinyltris(β-methoxy-ethoxy)silane, or 3-(meth)acryloxypropyltrimethoxysilane may be used as the silane coupling agent.

From the viewpoint of coating properties, the viscosity at 25° C. of the resin composition according to the present embodiment may be 0.5 Pa·s or more and 20 Pa·s or less, 0.8 Pa·s or more and 18 Pa·s or less, or 1 Pa·s or more and 15 Pa·s or less. The viscosity at 25° C. of the resin composition can be measured by using a rheometer “MCR-102” (manufactured by Anton Paar GmbH) under the conditions of a cone plate of CP25-2 and a shear rate of 10 s⁻¹.

The Young's modulus of a resin film obtained by ultraviolet-curing the resin composition under the conditions including an accumulated amount of light of 10 mJ/cm² and an illumination of 100 mW/cm² may be 0.20 MPa or more and 0.80 MPa or less at 23° C. When the Young's modulus of the resin film is 0.20 MPa or more, the low-temperature characteristics of the optical fiber are easily improved, and when the Young's modulus of the resin film is 0.80 MPa or less, the microbending resistance characteristics of the optical fiber are easily improved. The Young's modulus of the resin film may be 0.22 MPa or more, 0.24 MPa or more, or 0.25 MPa or more, and may be 0.75 MPa or less, 0.70 MPa or less, 0.65 MPa or less, or 0.60 MPa or less. From the viewpoint of achieving both the microbending resistance characteristics and the low-temperature characteristics, the Young's modulus of the resin film may be 0.25 MPa or more and 0.60 MPa or less.

### (Optical Fiber)

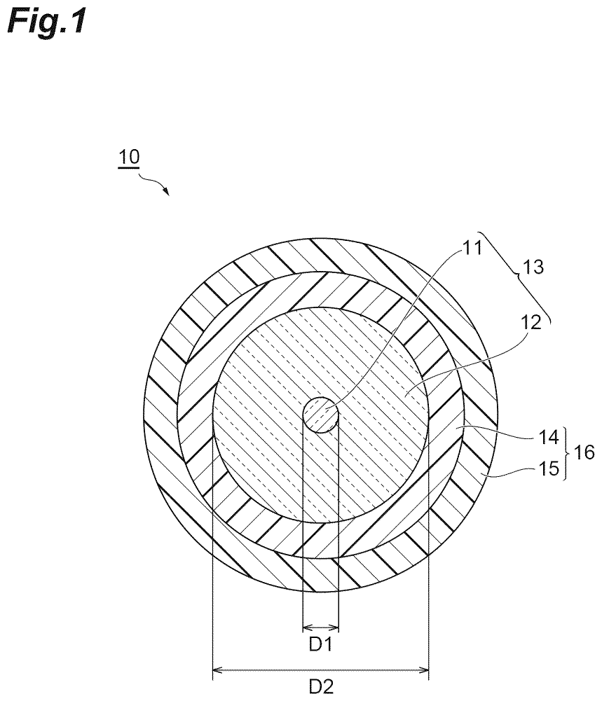

FIG. 1 is a schematic cross-sectional view showing an example of an optical fiber according to the present embodiment. The optical fiber 10 includes: a glass fiber 13 including a core 11 and a cladding 12; and a coating resin layer 16 including a primary resin layer 14 and a secondary resin layer 15 provided on the outer periphery of the glass fiber 13.

The cladding 12 surrounds the core 11. The core 11 and the cladding 12 mainly include glass such as quartz glass, and for example, germanium-added quartz glass or pure quartz glass can be used for the core 11, while pure quartz glass or fluorine-added quartz glass can be used for the cladding 12.

In FIG. 1, for example, the outer diameter of the glass fiber 13 (D2) is about 100 μm to 125 μm, and the diameter of the core 11 (D1) constituting the glass fiber 13 is about 7 μm to 15 μm. The thickness of the coating resin layer 16 is usually about 22 μm to 70 μm. The thickness of each layer of the primary resin layer 14 and the secondary resin layer 15 may be about 5 μm to 50 μm.

When the outer diameter of the glass fiber 13 is about 125 μm, and the thickness of the coating resin layer 16 is 60 μm or more and 70 μm or less, the thickness of each layer of the primary resin layer 14 and the secondary resin layer 15 may be about 10 μm to 50 μm, and for example, the thickness of the primary resin layer 14 may be 35 μm, while the thickness of secondary resin layer 15 may be 25 μm. The outer diameter of the optical fiber 10 may be about 245 μm to 265 μm.

When the outer diameter of the glass fiber 13 is about 125 μm, and the thickness of the coating resin layer 16 is 20 μm or more and 48 μm or less, the thickness of each layer of the primary resin layer 14 and the secondary resin layer 15 may be about 8 μm to 38 μm, and for example, the thickness of the primary resin layer 14 may be 25 μm, while the thickness of the secondary resin layer 15 may be 10 μm. The outer diameter of the optical fiber 10 may be about 165 μm to 221 μm.

When the outer diameter of the glass fiber 13 is about 100 μm, and the thickness of the coating resin layer 16 is 22 μm or more and 37 μm or less, the thickness of each layer of the primary resin layer 14 and the secondary resin layer 15 may be about 5 μm to 32 μm, and for example, the thickness of the primary resin layer 14 may be 25 μm, while the thickness of the secondary resin layer 15 may be 10 μm. The outer diameter of the optical fiber 10 may be about 144 μm to 174 μm.

When the resin composition according to the present embodiment is applied to the primary resin layer, optical fiber that is excellent in the microbending resistance characteristics and the low-temperature resistance characteristics can be produced.

A method for producing an optical fiber according to the present embodiment includes: an application step of applying the above resin composition on the outer periphery of a glass fiber including a core and a cladding; and a curing step of curing the resin composition by irradiating the resin composition with ultraviolet radiation after the application step.

From the viewpoint of improving the microbending resistance characteristics of the optical fiber, the Young's modulus of the primary resin layer may be 0.80 MPa or less, 0.75 MPa or less, 0.70 MPa or less, 0.65 MPa or less, or 0.60 MPa or less, at 23° C.±2° C. When the Young's modulus of the primary resin layer is more than 0.80 MPa, external force is easily transmitted to the glass fiber, and an increase in the transmission loss due to microbending may increase. From the viewpoint of improving the low-temperature characteristics of the optical fiber, the Young's modulus of the primary resin layer may be 0.05 MPa or more, 0.07 MPa or more, 0.10 MPa or more, 0.20 MPa or more, or 0.25 MPa or more, at 23° C.±2° C.

The Young's modulus of the primary resin layer can be measured by a pullout modulus (POM) method at 23° C. Two sites of an optical fiber are fixed with two chucking devices, the coating resin layer (primary resin layer and secondary resin layer) portion between the two chucking devices is removed, subsequently one chucking device is fixed, and the other chucking device is gently moved in a direction opposite to the fixed chucking device. When the length of the portion of the optical fiber clamped by the chucking device to be moved is designated as L, the amount of movement of the chucking device is designated as Z, the outer diameter of the primary resin layer is designated as Dp, the outer diameter of the glass fiber is designated as Df, the Poisson's ratio of the primary resin layer is designated as n, and the load at the time of moving the chucking device is designated as W, the Young's modulus of the primary resin layer can be determined from the following expression.

$$Young ' s modulus ( MPa ) = ( ( 1 + n ) W / π LZ ) \times ln ( Dp / Df )$$

The secondary resin layer 15 can be formed by, for example, curing a resin composition containing a photopolymerizable compound including a urethane (meth)acrylate, a photopolymerization initiator, and the like. The resin composition for forming the secondary resin layer has a composition different from that of the resin composition for primary coating. The resin composition for secondary coating can be prepared using a conventionally known technology.

From the viewpoint of improving the microbending resistance characteristics of the optical fiber, the Young's modulus of the secondary resin layer may be 600 MPa or more, 700 MPa or more, or 800 MPa or more, at 23° C.±2° C. The upper limit value of the Young's modulus of the secondary resin layer is not particularly limited; however, from the viewpoint of imparting moderate toughness to the secondary resin layer, the upper limit value may be 3000 MPa or less, 2500 MPa or less, or 2000 MPa or less, at 23° C.±2° C.

The Young's modulus of the secondary resin layer can be measured by the following method. First, an optical fiber is immersed in a mixed solvent of acetone and ethanol, and only the coating resin layer is pulled out in a tubular shape. At this time, the primary resin layer and the secondary resin layer are integrated; however, since the Young's modulus of the primary resin layer is 1/50000 or more and 1/1000 or less of the Young's modulus of the secondary resin layer, the Young's modulus of the primary resin layer can be neglected. Next, the solvent is removed from the coating resin layer by vacuum drying, subsequently a tensile test (tensile rate is 1 mm/min) is performed at 23° C., and the Young's modulus can be determined by a secant formula at 2.5% strain.

The method for producing an optical fiber according to the present embodiment can produce an optical fiber having excellent microbending resistance characteristics and low-temperature characteristics by using the resin composition according to the present embodiment as the resin composition for primary coating.

### (Optical Fiber Ribbon)

An optical fiber ribbon can be produced using the optical fiber according to the present embodiment. In the optical fiber ribbon, a plurality of the above optical fibers are arranged in parallel and are coated with a resin for a ribbon.

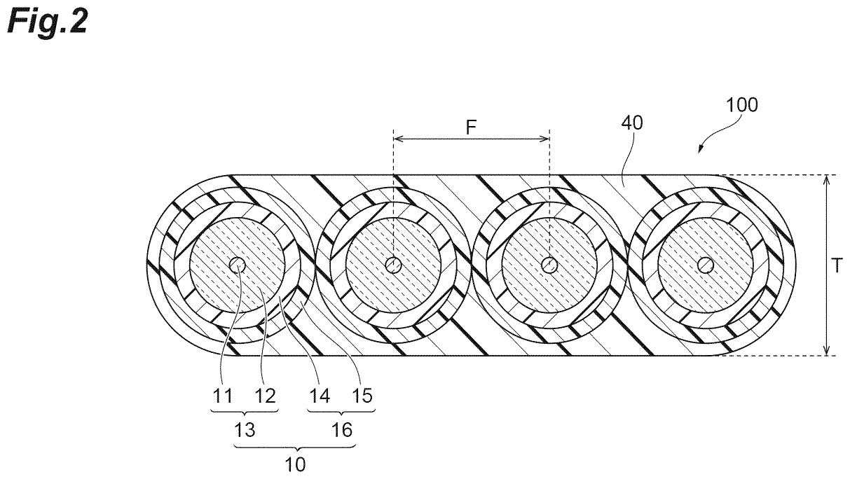

FIG. 2 is a schematic cross-sectional view showing the optical fiber ribbon according to an embodiment. The optical fiber ribbon 100 has a plurality of optical fibers 10 and a connective resin layer 40 in which the optical fibers 10 are (integrally) coated and connected by a resin for a ribbon. In FIG. 2, four optical fibers 10 are shown as an example; however, the number of the optical fibers is not particularly limited.

The optical fibers 10 may be integrated in a state of being arranged in parallel in contact with each other, or some or all of the optical fibers 10 may be integrated in a state of being arranged in parallel at regular intervals. The distance F between the centers of adjoining optical fibers 10 may be 220 μm or more and 280 μm or less. When the distance between the centers is set to 220 μm or more and 280 μm or less, the optical fibers are easily placed on existing V-shaped grooves, and an optical fiber ribbon having excellent simultaneous fusibility can be obtained. The thickness T of the optical fiber ribbon 100 may vary depending on the outer diameter of the optical fiber 10; however, the thickness T may be 164 μm or more and 285 μm or less.

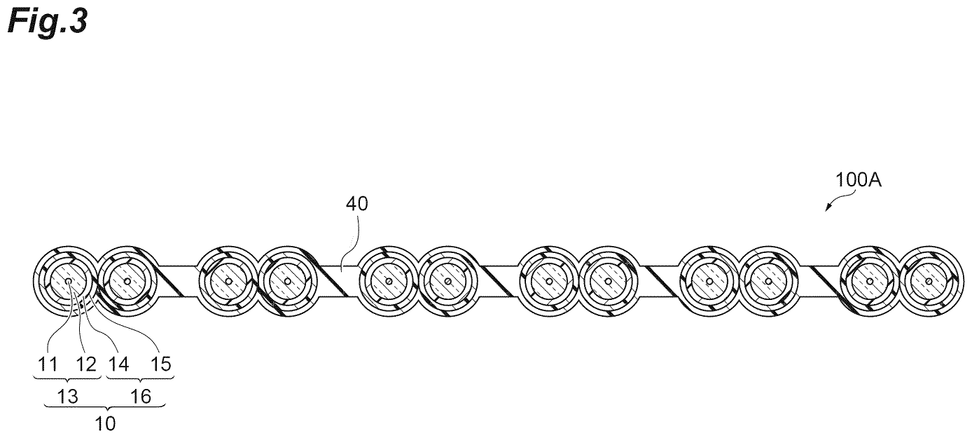

FIG. 3 is a schematic cross-sectional view showing an example of an optical fiber ribbon in which optical fibers are integrated in a state of being arranged in parallel at regular intervals. In the optical fiber ribbon 100A shown in FIG. 3, a total of twelve optical fibers 10 are connected in pairs at regular intervals with a resin for a ribbon. The resin for a ribbon forms a connective resin layer 40.

As the resin for a ribbon, a resin material that is generally known as a ribbon material can be used. From the viewpoints of the damage preventing property for the optical fiber 10, easy separability, and the like, the resin for a ribbon may contain a thermosetting resin such as a silicone resin, an epoxy resin, or a urethane resin; or an ultraviolet-curable resin such as epoxy acrylate, urethane acrylate, or polyester acrylate.

When the optical fibers 10 are arranged in parallel at regular intervals, that is, when adjoining optical fibers 10 are joined through a resin for a ribbon without being in contact with each other, the thickness of the connected part at the center between the optical fibers 10 may be 150 μm or more and 220 μm or less. From the viewpoint of being easily deformable when the optical fiber ribbon is accommodated in a cable, the optical fiber ribbon may have depressions at the connected parts of the optical fibers. A depression may be formed into a triangular shape with a narrowing angle on one surface of the connected part.

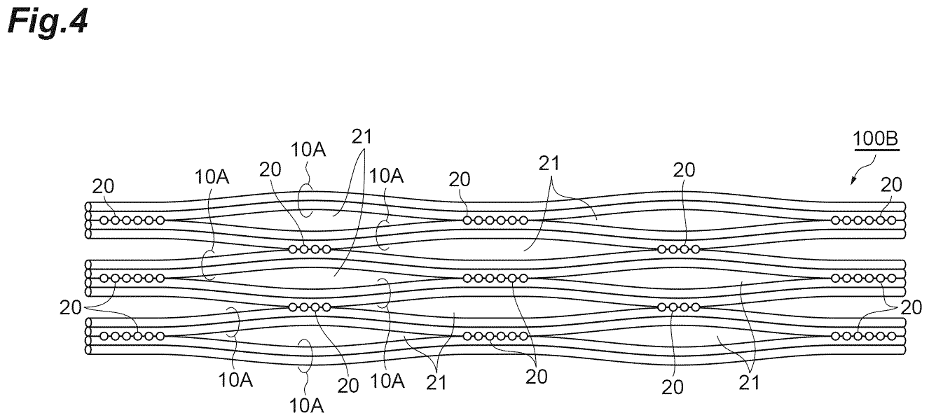

The optical fiber ribbon according to the present embodiment may have connected parts and unconnected parts intermittently in the longitudinal direction and the width direction. FIG. 4 is a plan view showing the appearance of the optical fiber ribbon according to an embodiment. The optical fiber ribbon 100B has a plurality of optical fibers, a plurality of connected parts 20, and unconnected parts (separated parts) 21. The unconnected parts 21 are formed intermittently in the longitudinal direction of the optical fiber ribbon. The optical fiber ribbon 100B is an intermittently connected type optical fiber ribbon in which connected parts 20 and unconnected parts 21 are intermittently provided in the longitudinal direction between each pair of two optical fibers 10A. The term “connected part” refers to a portion in which adjoining optical fibers are integrated by means of the connective resin layer, and the term “unconnected part” refers to a portion in which adjoining optical fibers are not integrated by means of the connective resin layer, and there are gaps between the optical fibers.

In the optical fiber ribbon having the above-mentioned configuration, since the connected parts 20 provided between each of the pairs of two cores are intermittently provided with the unconnected parts 21, the optical fiber ribbon is easily deformable. Therefore, when the optical fiber ribbon is packaged in an optical fiber cable, since the optical fiber ribbon can be easily rolled and packaged, the optical fiber ribbon can be produced as an optical fiber ribbon appropriate for high-density packaging. Furthermore, since the connected parts 20 can be easily torn from the unconnected parts 21 as starting points, the optical fibers 10 in the optical fiber ribbon are easily separated into single cores.

By using the above optical fiber, the optical fiber ribbon according to the present embodiment has excellent microbending resistance characteristics and low-temperature characteristics and can be packed at high density in an optical fiber cable.

### (Optical Fiber Cable)

With regard to an optical fiber cable according to the present embodiment, the above optical fiber ribbons are accommodated in a cable. Examples of the optical fiber cable include a slot type optical fiber cable having a plurality of slots (grooves). The above optical fiber ribbons can be packaged in the slots such that the packaging density in each slot is about 25% to 65%. The packaging density means the ratio of the cross-sectional area of optical fiber ribbons packaged in the slots with respect to the cross-sectional area of the slots. The optical fiber cable according to the present embodiment may be in the form in which a plurality of the above optical fibers are accommodated inside a cable without being coated with a resin for a ribbon.

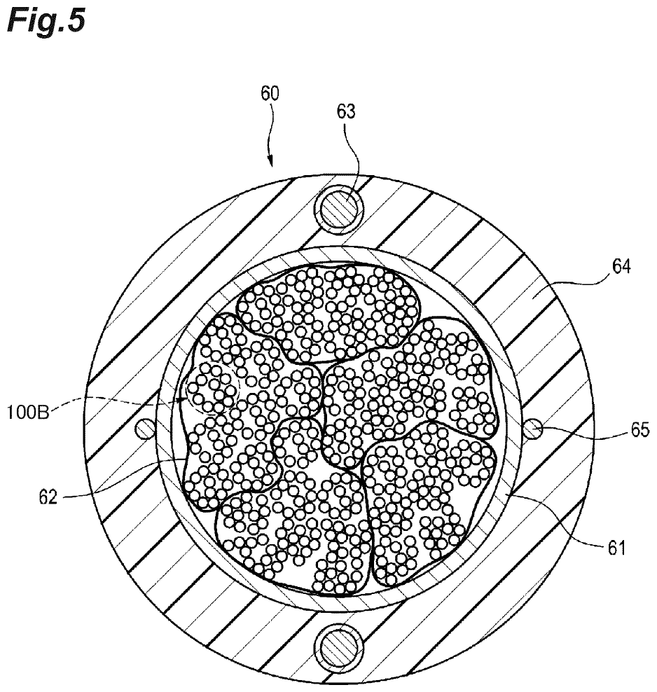

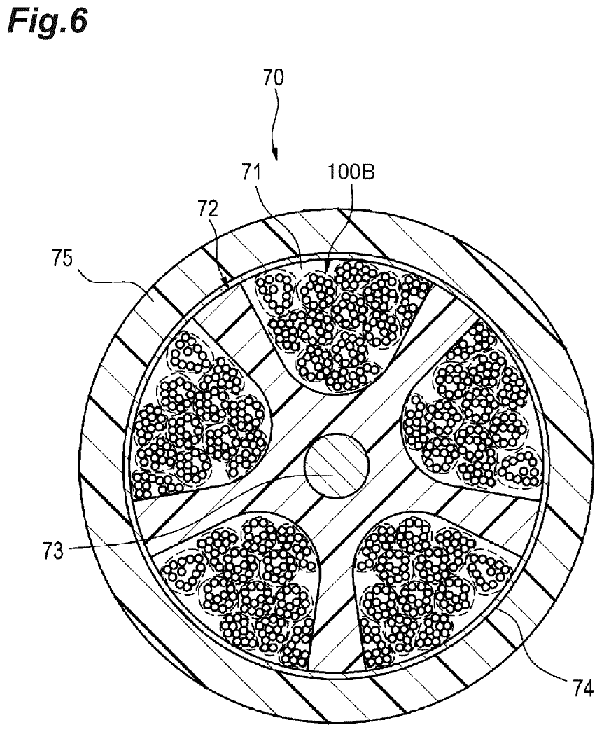

An example of the optical fiber cable according to the present embodiment will be described with reference to FIGS. 5 and 6. In FIGS. 5 and 6, intermittently connected type optical fiber ribbons are accommodated; however, a plurality of optical fibers that are not coated with a resin for a ribbon may be accommodated in a bundled state.

FIG. 5 is a schematic cross-sectional view of a slotless type optical fiber cable 60 in which the above-mentioned intermittently connected type optical fiber ribbons 100B is used. The optical fiber cable 60 has a cylindrical tube 61 and a plurality of optical fiber ribbons 100B. The plurality of optical fiber ribbons 100B may be bundled with an interposition 62 such as an aramid fiber. Furthermore, each of the plurality of optical fiber ribbons 100B may have a different marking. The optical fiber cable 60 has a structure formed by twisting a plurality of bundled optical fiber ribbons 100B, extrusion molding a resin that becomes the tube 61 around the optical fiber ribbons 100B, and covering the resultant together with tension members 63 with a jacket 64. In a case where waterproofing is required, a water-absorbing yarn may be inserted into the tube 61. The tube 61 can be formed by using, for example, a resin such as polybutylene terephthalate or a high-density polyethylene. A tear cord 65 may be provided on the outside of the tube 61.

FIG. 6 is a schematic cross-sectional view of a slot type optical fiber cable 70 that uses the above-mentioned intermittently connected type optical fiber ribbons 100B. The optical fiber cable 70 has a slot rod 72 having a plurality of slots 71, and a plurality of optical fiber ribbons 100B. The optical fiber cable 70 has a structure in which a plurality of slots 71 are radially provided on a slot rod 72 having a tension member 73 at the center. The plurality of slots 71 may be provided in a shape twisted in a spiral form or an SZ shape in the longitudinal direction of the optical fiber cable 70. In each slot 71, a plurality of optical fiber ribbons 100B that have been separated from a parallel state and arranged into a densely packed state are accommodated. Each of the optical fiber ribbon 100B may be bundled with a bundling material for identification. A press-winding tape 74 is wound around the slot rod 72, and a jacket 75 is formed around the press-winding tape 74. The jackets 64 and 75 are composed of, for example, polyvinyl chloride, polyethylene, or the like.

An optical fiber cable including the optical fiber or optical fiber ribbon according to the present embodiment has excellent microbending resistance characteristics and low-temperature characteristics.

### EXAMPLES

Hereinafter, the results of evaluation tests using Examples and Comparative Examples according to the present disclosure will be shown, and the present disclosure will be described in further detail. The present disclosure is not limited to these Examples.

### [Synthesis of Urethane Acrylate (A)]

### (A-1)

Polypropylene glycol having an Mn of 12000 (trade name “PREMINOL 54013F” produced by AGC, Inc.) and 2,4-tolylene diisocyanate (TDI) were reacted at 60° C. for 1 hour at a molar ratio of NCO and OH (NCO/OH) of 2.0, and an NCO-terminated prepolymer was prepared. During the reaction, 200 ppm of dibutyltin dilaurate as a catalyst was added thereto with respect to the final total fed amount, and 500 ppm of 2,6-di-tert-butyl-p-cresol (BHT) was added thereto as a polymerization inhibitor with respect to the final total fed amount. Next, 2-hydroxyethyl acrylate (HEA) was added thereto such that the molar ratio of OH with respect to NCO of the NCO-terminated prepolymer was 1.05, and the mixture was reacted at 60° C. for 1 hour to obtain a urethane acrylate (A-1). The urethane acrylate (A-1) had an Mn of 24500, an Mw of 29700, and an amount of vinyl groups of 0.159 mmol/g.

### (A-2)

A urethane acrylate (A-2) was obtained in the same manner as in the synthesis of the urethane acrylate (A-1), except that the polypropylene glycol having an Mn of 12000 was changed to a polypropylene glycol having an Mn of 18000 (trade name “PREMINOL 54318F” manufactured by AGC Inc.). The urethane acrylate (A-2) had an Mn of 36700, an Mw of 49000, and an amount of vinyl groups of 0.108 mmol/g.

### [Synthesis of Urethane Acrylate (B)]

### (B-1)

A urethane acrylate (B-1) was obtained in the same manner as in the synthesis of the urethane acrylate (A-1), except that the polypropylene glycol having an Mn of 12000 was changed to a polyoxypropylene monobutyl ether having an Mn of 3000 (trade name “PREMINOL 51004F” manufactured by AGC Inc.). The urethane acrylate (B-1) had an Mn of 6500, an Mw of 7300, and an amount of vinyl groups of 0.304 mmol/g.

### (B-2)

A urethane acrylate (B-2) was obtained in the same manner as in the synthesis of the urethane acrylate (A-1), except that the polypropylene glycol having an Mn of 12000 was changed to a polyoxypropylene monobutyl ether having an Mn of 5000 (trade name “ACROBUTE MB-90” manufactured by NOF CORPORATION). The urethane acrylate (B-2) had an Mn of 10000, an Mw of 16700, and an amount of vinyl groups of 0.189 mmol/g.

### (B-3)

ACROBUTE MB-90 and 2-acryloyloxyethyl isocyanate (trade name “KARENZ AOI” manufactured by Resonac Corporation) were reacted at 60° C. for 1 hour at a ratio of NCO/OH of 1.0, and a urethane acrylate (B-3) was obtained. During the reaction, 200 ppm of dibutyltin dilaurate as a catalyst was added thereto with respect to the final total fed amount, and 500 ppm of BHT as a polymerization inhibitor was added thereto with respect to the final total fed amount. The urethane acrylate (B-3) had an Mn of 8500, an Mw of 15700, and an amount of vinyl groups of 0.195 mmol/g.

As monomers of the resin composition for primary coating, nonylphenol polyethylene glycol acrylate (trade name “Miramer M164” manufactured by MIWON, amount of vinyl groups: 2.222 mmol/g), acryloylmorpholine (ACMO, amount of vinyl groups: 7.084 mmol/g), N-vinylcaprolactam (NVCL, amount of vinyl groups: 7.184 mmol/g), and neopentyl glycol diacrylate (NPG, amount of vinyl groups: 9.423 mmol/g) were prepared. As a photopolymerization initiator, 2,4,6-trimethylbenzoyldiphenylphosphine oxide (Omnirad TPO) was prepared. As a silane coupling agent, 3-acryloxypropyltrimethoxysilane (APTMS, amount of vinyl groups: 4.268 mmol/g) was prepared.

The Mn's of polypropylene glycol and polyoxypropylene monobutyl ether are values determined from the hydroxyl group values and are values described in the catalogue of manufactured products. The Mn and Mw of the urethane acrylates were measured using an ACQUITY APC RI manufactured by Waters Corporation under the conditions including the following: sample concentration: 0.2% by mass THF solution, injection amount: 20 μL, sample temperature: 15° C., mobile phase: THF, XT columns for organic solvent: particle size 2.5 μm, pore size 450 Å, column inner diameter 4.6×column length 150 mm+particle size 2.5 μm, pore size 125 Å, column inner diameter 4.6×column length 150 mm+particle size 1.7 μm, pore size 45 Å, column inner diameter 4.6×column length 150 mm, column temperature: 40° C., and flow rate: 0.8 mL/min.

### [Resin Composition for Primary Coating]

Urethane acrylates, monomers, photopolymerization initiators, and silane coupling agents in the blending amounts (parts by mass) indicated in Table 1 and Table 2 were mixed to produce a resin composition for primary coating of each Test Example. Test Examples 1 to 11 correspond to Examples, and Test Examples 12 to 14 correspond to Comparative Examples.

### [Resin Film]

The resin composition was applied on a polyethylene terephthalate (PET) film by using a spin coater, subsequently the resin composition was cured using an electrodeless UV lamp system (D Bulb, manufactured by Heraeus) under the conditions of 10 mJ/cm² and 100 mW/cm², and a resin film having a thickness of 200 μm was formed on the PET film. The resin film was obtained by peeling it from the PET film.

### (Young's Modulus)

The resin film was punched into a dumbbell shape of JIS K 7127 Type 5, the punched resin film was pulled under the conditions of 23±2° C. and 50±10% RH, by using a tensile testing machine under the conditions including a tensile rate of 1 mm/min and a gauge length of 25 mm, and a stress-strain curve was obtained. The Young's modulus of the resin film was determined by dividing the stress determined by a secant formula at 2.5% strain by the cross-sectional area of the resin film.

### [Resin Composition for Secondary Coating]

A urethane acrylate (Z-1) was obtained in the same manner as in the synthesis of the urethane acrylate (A-1), except that the polypropylene glycol having an Mn of 12000 was changed to a polypropylene glycol having an Mn of 600 (trade name “PP-600” manufactured by Sanyo Chemical Industries, Ltd.). The urethane acrylate (Z-1) had an Mn of 2300 and an Mw of 2700.

25 parts by mass of the urethane acrylate (Z-1), 36 parts by mass of tripropylene glycol diacrylate, 37 parts by mass of VISCOAT #540 (manufactured by OSAKA ORGANIC CHEMICAL INDUSTRY LTD.), 1 part by mass of Omnirad TPO, and 1 part by mass of 1-hydroxycyclohexyl phenyl ketone (Omnirad 184) were mixed to obtain a resin composition for secondary coating.

### [Optical Fiber]

The resin composition for primary coating and the resin composition for secondary coating were each applied on the outer peripheral surface of a glass fiber 13 having a diameter of 125 μm. Next, each of the resin compositions was cured by irradiating the resin composition with ultraviolet radiation, a coating resin layer 16 including a primary resin layer 14 and a secondary resin layer 15 was formed, and an optical fiber 10 was produced. The thickness of the primary resin layer 14 was set to 20 μm, the thickness of the secondary resin layer 15 was set to 15 μm, and an optical fiber having an outer diameter of 195 μm was obtained. Production of the optical fiber was carried out at a production speed of 2000 m/min and 3000 m/min.

### (Low-Temperature Characteristics)

The optical fiber was wound in one layer around a glass bobbin at a tension of 50 g, the transmission characteristics of signal light having a wavelength of 1550 nm were measured under each of the temperature conditions of 23° C., −40° C., and −60° C., and the transmission loss was determined. A case where the transmission loss difference obtained by subtracting the transmission loss at 23° C. from the transmission loss at −40° C. was less than 0 dB/km was evaluated as “A”; a case where the transmission loss difference was 0 dB/km or more and 0.01 dB/km or less was evaluated as “B”; and a case where the transmission loss difference was more than 0.01 dB/km was evaluated as “C”.

### (Microbending Resistance Characteristics)

The transmission loss of light at a wavelength of 1550 nm obtained when the optical fiber 10 was wound in a single layer around a bobbin having a diameter of 280 mm, the surface of which was covered with sandpaper, was measured by an optical time domain reflectometer (OTDR) method. The transmission loss of light having a wavelength of 1550 nm obtained when the optical fiber 10 was wound in a single layer around a bobbin without sandpaper and having a diameter of 280 mm was measured, and a case where the difference between the two transmission losses was less than 0.5 dB/km was evaluated as “A”; a case where the difference was 0.5 dB/km or more and 1.0 dB/km or less was evaluated as “B”; while a case where the difference was more than 1.0 dB/km was evaluated as “C”.

### (Eccentricity of Wall Thickness)

The eccentricity of the primary resin layer (minimum thickness of primary resin layer/maximum thickness of primary resin layer×100) was calculated by dividing the minimum thickness of the primary resin layer by the maximum thickness of the primary resin layer. A case where the eccentricity of wall thickness was 80% or more was evaluated as “A”; a case where the eccentricity of wall thickness was 70% or more and less than 8000 was evaluated as “B”; and a case where the eccentricity of wall thickness was less than 70% was evaluated as “C”.

TABLE 1

| | Amount of vinyl | Test Example | | | | | | | |
|---|---|---|---|---|---|---|---|---|---|
| | group (mmol/g) | 1 | 2 | 3 | 4 | 5 | 6 | 7 | 8 |
| A-1 | 0.159 | 20.0 | 20.0 | 25.0 | — | — | — | — | — |
| A-2 | 0.108 | — | — | — | 30.0 | 25.0 | 15.0 | 20.0 | 36.0 |
| B-1 | 0.304 | 50.0 | 50.0 | 60.0 | 45.0 | 50.0 | 75.0 | 70.0 | 48.0 |
| B-2 | 0.189 | — | — | — | — | — | — | — | — |
| B-3 | 0.195 | — | — | — | — | — | — | — | — |
| NVCL | 7.184 | 14.0 | 7.0 | 7.0 | 14.0 | 7.0 | 4.0 | 4.0 | 7.0 |
| ACMO | 7.084 | 5.0 | 2.0 | 2.0 | 5.0 | 2.0 | 4.0 | 4.0 | 7.0 |
| M164 | 2.222 | 9.0 | 19.0 | 4.0 | 4.0 | 14.0 | — | — | — |
| NPG | 9.423 | 0.5 | 0.5 | 0.5 | 0.5 | 0.5 | 0.5 | 0.5 | 0.5 |
| APTMS | 4.268 | 0.5 | 0.5 | 0.5 | 0.5 | 0.5 | 0.5 | 0.5 | 0.5 |
| TPO | — | 1.0 | 1.0 | 1.0 | 1.0 | 1.0 | 1.0 | 1.0 | 1.0 |
| Total amount of vinyl groups (mmol/100 g) | | 181.2 | 131.9 | 102.4 | 168.6 | 120.3 | 88.3 | 87.3 | 125.2 |
| Amount of vinyl groups of urethane acrylate (B)/ | | 4.8 | 4.8 | 4.6 | 4.2 | 5.6 | 14.1 | 9.9 | 3.8 |
| amount of vinyl groups of urethane acrylate (A) | | | | | | | | | |
| Young's modulus (MPa) | | 0.42 | 0.41 | 0.67 | 0.42 | 0.35 | 0.23 | 0.29 | 0.43 |
| Low-temperature | 2000 m/min | A | A | A | A | A | A | A | A |
| characteristics | 3000 m/min | B | A | A | A | A | B | A | A |
| Microbending resistance | 2000 m/min | A | A | B | A | A | A | A | A |
| characteristics | 3000 m/min | A | A | B | A | A | A | A | A |
| Eccentricity of | 2000 m/min | A | A | A | A | A | A | A | A |
| wall thickness | 3000 m/min | A | A | A | A | A | A | A | B |

TABLE 2

| | Amount of vinyl | Test Example | | | | | |
|---|---|---|---|---|---|---|---|
| | group (mmol/g) | 9 | 10 | 11 | 12 | 13 | 14 |
| A-1 | 0.159 | — | — | — | 15.0 | 10.0 | — |
| A-2 | 0.108 | 20.0 | 25.0 | 15.0 | — | — | 15.0 |
| B-1 | 0.304 | — | — | — | 40.0 | 80.0 | — |
| B-2 | 0.189 | 60.0 | — | 75.0 | — | — | 75.0 |
| B-3 | 0.195 | — | 60.0 | — | — | — | — |
| NVCL | 7.184 | 7.0 | 7.0 | 4.0 | 14.0 | 4.0 | 4.0 |
| ACMO | 7.084 | — | — | 4.0 | 5.0 | 4.0 | — |
| M164 | 2.222 | 11.0 | 6.0 | — | 24.0 | — | 4.0 |
| NPG | 9.423 | 0.5 | 0.5 | 0.5 | 0.5 | 0.5 | 0.5 |
| APTMS | 4.268 | 0.5 | 0.5 | 0.5 | 0.5 | 0.5 | 0.5 |
| TPO | — | 1.0 | 1.0 | 1.0 | 1.0 | 1.0 | 1.0 |
| Total amount of vinyl groups (mmol/100 g) | | 95.1 | 84.8 | 79.7 | 210.7 | 89.8 | 60.3 |
| Amount of vinyl groups of urethane acrylate (B)/ | | 5.3 | 4.3 | 8.8 | 5.1 | 15.3 | 8.8 |
| amount of vinyl groups of urethane acrylate (A) | | | | | | | |
| Young's modulus (MPa) | | 0.25 | 0.31 | 0.23 | 0.25 | 0.35 | 0.19 |
| Low-temperature | 2000 m/min | A | A | B | B | C | C |
| characteristics | 3000 m/min | A | A | B | C | C | C |
| Microbending resistance | 2000 m/min | A | A | A | A | A | A |
| characteristics | 3000 m/min | A | A | A | A | A | A |
| Eccentricity of | 2000 m/min | A | A | A | A | A | A |
| wall thickness | 3000 m/min | A | A | A | A | A | A |

### REFERENCE SIGNS LIST

10, 10A: optical fiber
11: core
12: clad
13: glass fiber
14: primary resin layer
15: secondary resin layer
16: coating resin layer
20: connected portion
21: unconnected portion
40: connecting resin layer
60, 70: optical fiber cable
61: tube
62: intervention
63, 73: tension member
64, 75: external coat
65: tear string
71: slot
72: slot rod
74: wrapping tape
100, 100A, 100B: optical fiber ribbon
D1: diameter
D2: outer diameter
F: center-to-center distance
T: thickness.

What is claimed is:

1. A resin composition for primary coating of an optical fiber, the resin composition comprising photopolymerizable compounds including a bifunctional urethane (meth)acrylate (A) and a monofunctional urethane (meth)acrylate (B), a photopolymerization initiator, and a silane coupling agent,
wherein the urethane (meth)acrylate (A) is a reaction product of a diol having a number average molecular weight of 8000 or more and 20000 or less, a diisocyanate, and a hydroxyl group-containing (meth)acrylate, and
a total amount of vinyl groups in 100 parts by mass of a total amount of the resin composition is 70 mmol or more and 200 mmol or less, and a ratio of an amount of vinyl groups of the urethane (meth)acrylate (B) with respect to an amount of vinyl groups of the urethane (meth)acrylate (A) is 3.7 or more and 15.0 or less.

2. The resin composition according to claim 1, wherein the total amount of vinyl groups in 100 parts by mass of the total amount of the resin composition is 80 mmol or more and 180 mmol or less.

3. The resin composition according to claim 1, wherein the ratio of the amount of vinyl groups of the urethane (meth)acrylate (B) with respect to the amount of vinyl groups of the urethane (meth)acrylate (A) is 4.0 or more and 10.0 or less.

4. The resin composition according to claim 1, wherein based on 100 parts by mass of the total amount of the resin composition, a content of the urethane (meth)acrylate (A) is 10 parts by mass or more and 40 parts by mass or less, and a content of the urethane (meth)acrylate (B) is 30 parts by mass or more and 80 parts by mass or less.

5. The resin composition according to claim 1, wherein the urethane (meth)acrylate (B) is a reaction product of a monool having a number average molecular weight of 2000 or more and 10000 or less, a diisocyanate, and a hydroxyl group-containing (meth)acrylate.

6. The resin composition according to claim 1, wherein the photopolymerizable compounds further include an N-vinyl compound, and a content of the N-vinyl compound is 1 part by mass or more and 15 parts by mass or less based on 100 parts by mass of the total amount of the resin composition.

7. The resin composition according to claim 1, wherein a Young's modulus of a resin film obtained when the resin composition is ultraviolet-cured under conditions including an accumulated amount of light of 10 mJ/cm² and an illumination of 100 mW/cm² is 0.20 MPa or more and 0.80 MPa or less at 23° C.

8. The resin composition according to claim 7, wherein the Young's modulus of the resin film is 0.25 MPa or more and 0.60 MPa or less at 23° C.

9. An optical fiber comprising:
a glass fiber including a core and a cladding;
a primary resin layer coating the glass fiber in contact with the glass fiber; and
a secondary resin layer coating the primary resin layer,
wherein the primary resin layer includes a cured product of the resin composition according to claim 1.

10. A method for producing an optical fiber, the method comprising:
an application step of applying the resin composition according to claim 1 on an outer periphery of a glass fiber including a core and a cladding; and
a curing step of curing the resin composition by irradiating the resin composition with ultraviolet radiation after the application step.

11. An optical fiber ribbon, wherein a plurality of the optical fibers according to claim 9 are arranged in parallel and are coated with a resin for a ribbon.

12. An optical fiber cable, wherein the optical fiber ribbon according to claim 11 is accommodated in a cable.

13. An optical fiber cable, wherein a plurality of the optical fibers according to claim 9 are accommodated in a cable.
